(19) United States
(12) Patent Application Publication
(10) Pub. No.: US 2008/0138612 A1
(43) Pub. Date: Jun. 12, 2008

(54) Glass Member, Reading Glass, Reading Apparatus Using the Same, and Image Forming Apparatus

(76) Inventors: Yoshikazu Kondo, Tokyo (JP); Atsushi Saito, Tokyo (JP); Takahide Toyama, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/795,365

(22) PCT Filed: Jan. 11, 2006
(86) PCT No.: PCT/JP06/00191

§ 371 Date: Jul. 16, 2007

(30) Foreign Application Priority Data
Jan. 26, 2005 (JP) 2005-017897

(51) Int. Cl. B32B 17/06

(52) U.S. Cl. 428/336; 428/426

(57) ABSTRACT

The object of the present invention is to provide:

a glass member characterized by excellent friction resistance property, and antifouling property;

a reading glass wherein, when this glass member is used as the reading glass of a scanner or a copier, toner, dust or adhesive does not easily deposit on the reading glass, with the result that deterioration in the copied image quality such as black spots or black streaks can be avoided;

and a scanner or a copier wherein the glass is used.

The glass member including a glass substrate including a fluorine containing film coated directly, not through any other layer interposed, on at least one surface of the glass substrate, wherein an element composition of the fluorine containing film is characterized in that a content of fluorine atoms exceeds 30 atomic percent, and an atomic ratio of oxygen atom to fluorine atom (O/F) is between 0.2 and 1.0.

### TECHNICAL FIELD

The present invention relates to a glass member characterized by excellent abrasion resistance and antifouling property, reading glass mounted on a scanner of a Plain Paper photocopier or the like, a reading apparatus using the same and an image forming apparatus.

### BACKGROUND

For example, a light transmitting member intended to correctly regulate and arrange a document at a focussing position is used in a reading apparatus for optically reading a document. Unprocessed glass or glass processed to have antistatic or lubricating properties on the surface thereof is used as such a light transmitting member. The light transmitting member is also used as a lens of various types and window glass, in addition to the aforementioned reading glass.

The aforementioned light transmitting member provided with excellent surface lubricating and antistatic properties has come to employed as the reading glass of the automatic document feed type copier using electrophotographic process.

To prevent a paper jam resulting from static electricity at the time of document supply, techniques have been proposed wherein the surface of the reading glass is coated with a transparent conductive film such as the ITO film (film of tin doped indium oxide) and tin oxide film to ensure that static electricity is not produced (see Patent Documents 1 through 3 for example). If the surface of the reading glass has a greater friction coefficient, paper jam tends to occur easily. To prevent this, the surface of the glass is coated with lubricant, according to the conventional method.

In the Patent Document 1, a conductive film is coated on the entire surface of the reading glass and is provided with a process of reducing friction so that a portion with greater friction with a document and a portion with smaller friction with a document are formed. The portion in contact with the conveying roller corresponds to the portion with smaller friction, whereby conveying efficiency is improved.

In the Patent Document 2, the reading glass is coated with the tin oxide film so that the surface roughness Ra does not exceed 3 nm.

In the Patent Document 3, an ITO film is formed on at least one surface of the reading glass to a thickness of 15 through 20 nm.

In the aforementioned examples, however, the following disadvantages can be pointed out: Needless to say, when such a glass member is used as a glass member for other than the reading glass of a scanner, it is characterized by poor friction resistance and antifouling property.

(1) The aforementioned antistatic film has a hardness of HB through 5 H in terms of pencil hardness test. Even if the lower friction layer laminated on the aforementioned antistatic film is strong, the underlying antistatic film (transparent conductive film) is weak and is peeled off by friction with paper. There is a difference of about 2% through 3% in the transmittance between the portion on the surface of the reading glass with a conductive film formed thereon and the portion with the film being separated. In the strict sense of the word, deterioration in image quality occurs where the film is separated. Further, foreign substances such as tacky substances will deposit where the film is separated, and such a failure as a black streak will result.

(2) In the method wherein no film is formed on the portion wherein film separation may occur, there is difference in transmittance between the portion with film and the portion without film. In a gray document image of lower density, the subtle difference in light transmittance on the boundary may become visible as an actual image. Further, contamination occurs to a minute level difference on the boundary with the non film portion and may cause deterioration of image quality.

(3) Another problem with the aforementioned conventional method is that the lubricant to be used such as silicon and fluorine lubricant is capable of smoothly feeding the document with smaller friction, but is incapable of reducing the deposition of the power of paper or adhesive brought in by the document. In particular, the fluorine lubricant layer has its molecular structure fixed by the greater size of he fluorine atom, and this has been the cause for poor resistance to external force (friction resistance of the document).

Patent Document 1: Unexamined Japanese Patent Application Publication No. 8-6177

Patent Document 2: Unexamined Japanese Patent Application Publication No. 9-208264

Patent Document 3: Unexamined Japanese Patent Application Publication No. 2002-328439

### DISCLOSURE OF INVENTION

### Problems to be Solved by the Invention

The object of the present invention is to solve the aforementioned problems and to provide:

a glass member characterized by excellent friction resistance property, antistatic property and antifouling property;

a reading glass wherein, when this glass member is used as the reading glass of the scanner or the like, toner, dust or adhesive does not easily deposit on the reading glass, with the result that deterioration in the copied image quality such as black spots or black streaks can be avoided;

a reading apparatus using the reading glass; and

an image forming apparatus using the reading glass.

### Means for Solving the Problems

The aforementioned object of the present invention can be achieved by the following Structures:

1. A glass member comprising: a glass substrate including a fluorine containing film coated directly, not through any other layer interposed, on at least one surface of the glass substrate, wherein an element composition of the fluorine containing film is characterized in that a content of fluorine atoms exceeds 30 atomic percent, and the atomic ratio of oxygen atom to fluorine atom (O/F) is between 0.2 and 1.0.

2. A reading glass located between a light source and a document in a scanner for optically reading the document, wherein a fluorine containing film is coated directly, not through any other layer interposed, on at least one surface of the glass substrate, and an element composition of the fluorine containing film is characterized in that a content of fluorine atoms exceeds 30 atomic percent, and an atomic ratio of oxygen atom to fluorine atom (O/F) is between 0.2 and 1.0.

3. The reading glass of the aforementioned Structure 2 wherein, before the fluorine containing film is formed, the surface of the glass substrate is provided with at least one of activations selected from among a corona treatment, a plasma treatment, an atmospheric pressure plasma treatment, and a flame treatment.

4. The reading glass of the Structure 3 wherein the activation is the atmospheric pressure plasma treatment.

5. The reading glass of any one of the Structures 2 through the Structures 4 wherein the fluorine containing film partly includes an optical film to a thickness of 4 nm or less.

6. The reading glass of any one of the Structures 2 through the Structures 5 wherein a surface opposite a surface of the glass substrate with the fluorine containing film coated thereon includes an antistatic layer.

7. The reading glass of any one of the Structures 1 through the Structures 6 wherein both surfaces of the glass substrate include the fluorine containing film.

8. The reading glass of any one of the Structures 1 through the Structures 7 wherein the process of forming the fluorine containing film is a wet coating process.

9. A reading apparatus utilizing the reading glass of any one of the Structures 1 through the Structures 8.

10. An image forming apparatus provided with the reading apparatus of the Structure 9.

### EFFECTS OF THE INVENTION

The present invention allows a glass substrate to be coated with a thin film of great strength and low friction, thereby ensuring easy and less costly production of a glass member excelling in antifouling property and conveying performance; solves the problems of excessively low level of the friction resistance in a conductive film by forming a transparent conductive film on the rear surface of the glass member; and provides a glass member capable of preventing electrostatic charge on the glass surface and hence preventing dust from being deposited thereon due to electrostatic charge, a reading apparatus utilizing the same as a reading glass, and an image forming apparatus.

### BRIEF DESCRIPTION OF THE DRAWINGS

FIG. 1 is a schematic diagram representing an example of two-step type atmospheric pressure plasma apparatus; and

FIG. 2 is a schematic diagram representing the cross section of an example of the image forming apparatus utilizing the reading glass of the present invention.

### LEGENDS

3, 7 Rectangular electrode

4. Substrate

8. Traveling frame electrode (first electrode)

9. Support base

10. Discharge gas

11. Thin film forming gas

12. Auxiliary gas

13. Discharge gas

14. Oxidizing gas

31, 33, 35. High frequency power source

101. Image forming apparatus

122, 124. Sheet feed tray

130, 131. Mirror unit

135. CCD

A. Automatic document feed apparatus (abbreviated as ADF)

B. Document image reading section

D. Writing section

E. Image forming section

G. Reading glass

H. Fixing section

### DESCRIPTION OF THE PREFERRED EMBODIMENT

The following describes the further details of the present invention:

To solve the aforementioned problems, the present invention provides a low friction resistance layer excelling in durability, antifouling property and conveying performance (lubricating performance) by using the glass member or reading glass wherein a fluorine containing film is coated on the outer surface of the glass substrate, and the element composition of the fluorine containing film is characterized in that the content of fluorine atoms exceeds 30 atomic percent, and the atomic ratio of oxygen atom to fluorine atom (O/F) exceeds 0.2 but is less than 1.0.

In the present invention, one of the ways preferably utilized to meet the requirement that the content of fluorine atoms exceeds 30 atomic percent in the element composition is the technique wherein, after the surface of the glass substrate has been activated (to be described later), a fluorine containing solution is coated thereon directly, not through any other layer interposed. If the glass substrate surface has been activated, the atomicity of the fluorine content in the fluorine containing film can be increased without changing the coating solution. The preferably used fluorine containing coating solutions will be shown later.

The element decomposition of the coating film containing fluorine atoms can be made to meet the requirement that the atomic ratio of oxygen atom to fluorine atom (O/F) exceeds 0.2 but is less than 1.0 by selecting the fluorine containing coating solution that meets the requirement of this composition range. Such a solution will be exemplified later.

There is no particular restriction to the type of the fluorine containing film forming compound constituting the fluorine containing coating solution. The silane coupling agent containing fluorine is preferably used.

There is no particular restriction to the type of the silane coupling agent preferably used in the present invention if the element composition by the XPS on the surface with the film formed thereon meets the requirement of the particular atomicity range specified in the present invention. It preferably contains the substituent group in the molecular structure wherein oxygen is used for connection between alkyl fluorides. For example, fluoroether based per-fluoroalkoxy per-fluoroalkoxy triisopropoxy silane can be mentioned. Inclusion of oxygen atoms in the substituent group provides a flexible structure to the substituent group, which, in turn, provides a thin film of great strength and low friction, according to the finding of the present inventors. Such a silane coupling agent is exemplified by the commercially available products including the Optool DSX from Daikin Industries Ltd. and Sitop from Asahi Glass Co., Ltd.

There is no particular restriction to the method of coating the fluorine containing film on the surface of a glass substrate using the aforementioned silane coupling agent, as exemplified by the spin coating method, dip coating method, extrusion coating method, roll coating/spray coating method, gravure coating method, wire bar method, and air knife method. The dip coating method is simple and preferably used, wherein the silane coupling agent is diluted with a solvent, and a glass substrate is dipped and coated in the solvent.

In the present invention, the fluorine containing film is coated directly, not through any other layer interposed, on at least one surface of the glass substrate. Further, the fluorine containing film can be coated on both sides of the glass substrate. Use of the aforementioned dip coating method permits both sides to be coated simultaneously, and hence, this procedure is preferably used.

In the present invention, before the fluorine containing film is formed on one side of the glass substrate, the surface of the aforementioned glass substrate is preferably provided with at least one of activation processing steps selected from among the corona treatment, plasma treatment, atmospheric pressure plasma treatment, and flame treatment. Use of the atmospheric pressure plasma treatment, and flame treatment (to be described later) in particular permits formation of a fluorine containing film characterized by excellent durability, and hence this procedure is preferably used.

In the present invention, the surface opposite the surface of the glass substrate with the fluorine containing film coated thereon (one of the surfaces if both surfaces are coated with the fluorine containing film) preferably includes an antistatic layer in particular, when used as a reading glass, according to the finding of the present inventors. The antistatic effect on the surface is provided by the rear surface electrode effect even when a conductive film is formed on the surface opposite to the surface in contact with the document wherein the fluorine containing film of low friction is formed, according to the finding of the present inventors.

To be more specific, when the surface is charged, the electric line of force rises perpendicularly to the surface (toward the ground). If a conductive layer is located on the rear surface, the electrostatic charge on the front surface is lost when the electric line of force faces the rear surface (disappears below). This arrangement suppresses electric suction of dust and others.

This antistatic transparent conductive film is preferably connected to the ground. Indium oxide, tin doped indium oxide (ITO) or tin oxide film is preferably used as the transparent conductive film. The surface resistivity is preferably 10⁹ ohms/square or less, more preferably 10⁶ ohms/square or less. These films are preferably coated, for example, according to vacuum vapor deposition method, sputtering method, or CVD method.

In the conventional art, the aforementioned transparent conductive film is soft, and hence the layer together with the transparent conductive film may be separated even when a low-friction layer is formed thereon. In the preferred embodiment of the present invention, a transparent conductive film of low film surface strength is formed on the rear surface of the glass substrate (surface not in contact with the document), and the fluorine containing film of the present invention is coated directly, not through any other layer interposed, on the top surface of the glass substrate (surface in contact with the document). This arrangement provides a glass substrate and reading glass excelling in friction resistance, film strength, antifouling property, conveying performance and durability, without toner and paper powder being deposited at a low electrostatic charge.

<<Measurement by XPS>>

The element composition (atomic ratio) of the fluorine containing film specified in the present invention can be measured by the XPS surface analysis apparatus. Any type of the XPS surface analysis apparatus can be used. In the example of the present invention, Model ESCALAB-200R, a product by VG Scientific Co., Ltd. was used. To measure the surface layer of the fluorine containing film, the angle (take-off angle) formed by the sample and detector was measured at an angle of 30°.

<<Atmospheric Pressure Plasma Method>>

In the glass substrate and reading glass of the present invention, the atmospheric pressure plasma method is preferably used to activate the front surface of the glass substrate and to form a transparent conductive film on the rear surface of the glass substrate. Referring to drawings, the following describes the atmospheric pressure plasma method of the present invention.

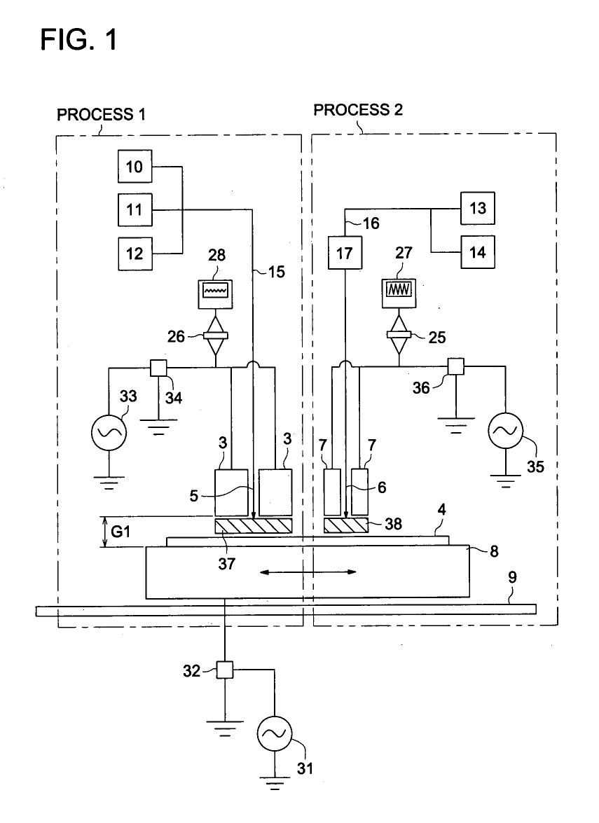

FIG. 1 is a schematic diagram representing an example of two-step type atmospheric pressure plasma apparatus. In the process 1 (area enclosed by a one-dot chain line in FIG. 1), counter electrodes (discharge space) are formed by a traveling frame electrode (first electrode) 8 and rectangular electrode (second electrode) 3, and high frequency electric field is applied between these electrodes. A gas 1 including a discharge gas 10, thin film forming gas 11 and auxiliary gas 12 is supplied through a gas supply pipe 15, and is led into the discharge space through a slit 5 formed on the rectangular electrode 3. The gas 1 is excited by discharge plasma, and the surface of the substrate 4 (glass substrate) placed on the traveling frame electrode 8 is exposed to the excited gas (37 in the drawing), whereby a thin film is formed on the surface of the substrate.

The substrate 4 together with the traveling frame electrode 8 gradually moves to the process 2 (area enclosed by a two-dot chain line).

In the process 2, counter electrodes (discharge space) are created by the traveling frame electrode (first electrode) 8 and rectangular electrode (second electrode) 7, and high frequency electric field is applied between the counter electrodes. A gas 2 including a discharge gas 13 and oxidizing gas 14 is supplied through a gas supply pipe 16, and is led into the discharge space through a slit 6 formed on the rectangular electrode 7. The gas 2 is excited by discharge plasma, and the surface of the substrate 4 placed on the traveling frame electrode 8 is exposed to the excited gas 2 (38 in the drawing), whereby a thin film formed on the surface of the substrate is oxidized. The traveling frame electrode 8 is provided with a traveling unit (not illustrated) capable of traveling back and forth on the support base 9 and stopping.

To adjust the temperature of the gas 2, a temperature regulating unit 17 is preferably arranged at some midpoint in of the supply pipe 16.

A thin film having a desired thickness can be formed through back-and-forth traveling by the traveling frame between the thin film forming process as this process 1 and the oxidizing process as the process 2.

The first electrode (traveling frame electrode) 8 is connected with a first power source 31 and the second electrode 3 is connected with the second power source 33. A first filter 32 and a second filter 34 are connected between these electrodes and power sources. The first filter 32 discourages the passage of the current having the frequency from the first power source 31, and encourages the passage of the current having the frequency from the second power source 33. The second filter 34 behaves to the contrary; it discourages the passage of the current having the frequency from the second power source 33, and encourages the passage of the current having the frequency from the first power source 31. In this manner, filters having their own intrinsic functions are employed.

In the process 1 of the atmospheric pressure plasma apparatus of FIG. 1, the high frequency electric field is applied between the counter electrodes made up of the first electrode 8 and second electrode 3; namely, the first high frequency electric field having a frequency of ω1, a field intensity of V1, and a current of I1 from the first power source 31 are applied to the first electrode 8, and the second high frequency electric field having a frequency of ω2, a field intensity of V2, and a current of I2 from the second power source 33 are applied to the second electrode 3. The first power source 31 can apply higher intensity of the high frequency electric field higher than the second power source 33(V1>V2), and the first frequency ω1 of first power source 8 can be applied lower than the second frequency ω2 of the second power source 33.

Similarly, in the process 2, the high frequency electric field is applied between the counter electrodes made up of the first electrode 8 and third electrode 7; namely, the first high frequency electric field having a frequency of ω1, a field intensity of V1 and a current of I1 is applied to the first electrode 8 by the first power source 31; and, the third high frequency electric field having a frequency of ω3, a field intensity of V3 and a current of I3 35 is applied to the third electrode 7 by the third power source.

The first power source 31 can apply higher intensity of the high frequency electric field higher than the third power source 35(V1>V3), and the first frequency ω1 of first power source 8 can be applied lower than the third frequency ω3 of the second power source 33.

FIG. 1 also shows the measuring instrument used to measure the intensity (intensity of the electric field) of the aforementioned high frequency electric field and the intensity IV1 of the discharge start electric field. The reference numerals 25 and 26 indicate a high frequency voltage probe, and reference numerals 27 and 28 indicate an oscilloscope.

As described above, a satisfactory plasma discharge can be formed by superimposing two high frequency electric fields having different frequencies to the rectangular electrode 3 and traveling frame electrode 8 constituting the counter electrodes even when a less costly gas such as nitrogen gas is employed. A thin film characterized by excellent properties can be produced by processing in an oxidizing atmosphere immediately thereafter.

Needless to say, atmospheric pressure plasma treatment can be provided by one high frequency power source, by selecting a discharger gas, auxiliary gas or thin film forming gas, without having to superimpose the high frequency electric field.

The surface of the glass substrate can be activated by applying a high frequency electric field in the process 1 alone, and selecting a discharge gas or auxiliary gas, without the thin film forming gas being supplied.

The following describes the image forming apparatus wherein a glass member is used as a reading glass:

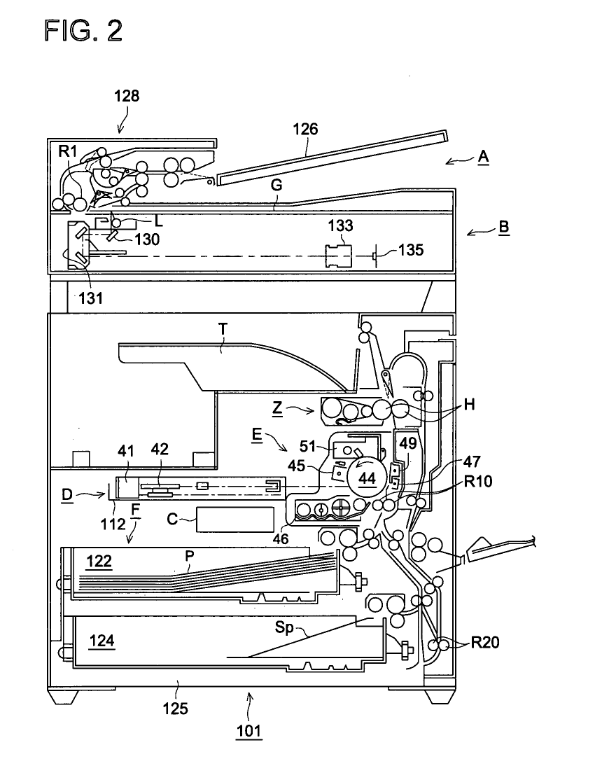

FIG. 2 is a schematic diagram representing the cross section of an example of the image forming apparatus utilizing the reading glass of the present invention.

In FIG. 2, the image forming apparatus 101 incorporates:

a document image reading section B for reading the image of the document conveyed by an automatic document feed apparatus (commonly abbreviated as ADF) A and an automatic document conveying apparatus;

an image control substrate C for processing the document image having been read;

a writing section D including a writing unit 112 for writing on a photoreceptor drum 44 as an image carrier in response to the data subsequent to image processing;

an image forming section E including the image forming units such as a photoreceptor drum 44, a charging device 45 around the same, a developing unit 46 made up of a magnetic brush type developing apparatus, a transfer unit 47, separator 49 and cleaner 51; and

a storage section F for the sheet supply trays 122 and 124 for storing the transfer material P.

The automatic document feed apparatus A is mainly made of a document platen 126, a roller group including a roller R1, and a document conveyance processor 128 including the switching unit (without reference numeral) for properly switching the document path.

The document image reading section B is located below the reading glass G and incorporates two mirror units 130 and 131 capable of back-and-forth traveling by maintaining an optical path, a fixed imaging lens 133 (hereinafter simply referred to as “lens”) and a line image sense device 135 (hereinafter referred to as “CCD”). The writing section D incorporates a laser light source 41 and polygon mirror (deflector) 42.

The R10 shown on the front of a transfer unit 47 as viewed from the direction of the traveling transfer material P indicates a registration roller, and “H” shown downstream from the separator 49 indicates a fixing unit.

The fixing unit H in the present embodiment includes a roller incorporating a heating source, and a press roller that rotates in press-contact with this roller.

“Z” is a cleaning unit for the fixing unit H and the major component is a cleaning web capable of winding.

One document (not illustrated) placed on the document platen 126 is conveyed by the document conveyance processor 128 and is subjected to exposure by the exposure unit L while traveling under the roller R1.

The light reflected from the document forms an image on the CCD 135 through the mirror units 130, 131 and lens 133, and the image is read.

The image information read by the document image reading section B is processed by the image processing unit, and is stored in the memory on the image control substrate C after having been encoded.

The image data is retrieved in response to image formation and the laser light source 41 of the writing section D is driven accordance with the image data. Then exposure is performed on the photoreceptor drum 44.

The reading glass of the present invention is applied to the image forming apparatus for monochromatic image as well as the image forming apparatus for color image. For example, it is possible to mention an image forming method wherein a plurality of image forming units are provided, and visible images (toner images) of different colors are formed by these image forming units, whereby full-color toner images are formed.

### EXAMPLE OF EMBODIMENT

<<Production of Glass Sample>>

The following procedures were used to produce a reading glass sample:

### Comparative Example 1

The ITO as a transparent conductive film was is coated on a glass substrate (a 3 mm thick reinforced glass manufactured by Nippon Sheet Glass Co., Ltd.) by a vapor deposition method, and a fluorine containing film was further coated thereon according to the following method, whereby a reading glass was produced.

The heptadecafluoro desyl triisopropoxy silane from GE Toshiba Silicon Inc. as a silane coupling agent for forming a fluorine containing film was coated by a dip coating method. The film thickness was measured by the thin film XRD, and the measurement was 3.0 nm. The element composition on the surface of the film was measured by XPS with the detector angle of near 30°. It was revealed that the content of fluorine atoms on the surface was 35 atomic percent, the content of oxygen atoms was 6 atomic percent, and the O/F was 0.17.

### Comparative Example 2

The fluorine containing film was coated on a glass substrate (a 3-mm thick reinforced glass manufactured by Nippon Sheet Glass Co., Ltd.) by the following method, whereby a reading glass was produced.

The silane coupling agent constituting the fluorine containing film was prepared by diluting the Optool from Daikin Industries Ltd. with SOL-1 of the same company to 0.1% and coating the resulting mixture according to the dip coating method.

The film thickness was measured by the thin film XRD, and the measurement was 3.4 nm. The element composition on the surface of the film was measured by XPS with the detector angle of near 30°. It was revealed that the content of fluorine atoms on the surface was 17 atomic percent, the content of oxygen atoms was 6 atomic percent, and the O/F was 1.64.

### Example 1

Reading glass was produced using the same procedure as that of the aforementioned Comparative example 2, except that the surface of the glass substrate was activated by corona discharging (using the AP-400 from Kasuga Denki Co., Ltd., processed for 30 seconds with a gap of 3 mm) before the fluorine containing film was coated. The film thickness was measured by the thin film XRD, and the measurement was 3.8 nm. The element composition on the surface of the film was measured by XPS with the detector angle of near 30°. It was revealed that the content of fluorine atoms on the surface was 50 atomic percent, the content of oxygen atoms was 19 atomic percent, and the O/F was 0.38.

### Example 2

Reading glass was produced using the same procedure as that of the aforementioned Comparative example 2, except that the surface of the glass substrate was activated by the atmospheric pressure plasma method (to be described later) before the fluorine containing film was coated. The film thickness was measured by the thin film XRD, and the measurement was 3.8 nm. The element composition on the surface of the film was measured by XPS with the detector angle of near 30°. It was revealed that the content of fluorine atoms on the surface was 50 atomic percent, the content of oxygen atoms was 16 atomic percent, and the O/F was 0.32.

### Example 3

Reading glass was produced using the same procedure as that of the aforementioned Example 1, except that a conductive SnO₂ film having a thickness of 30 nm was formed on the rear surface by the atmospheric pressure plasma method (to be described later) before the fluorine containing film was coated. The film thickness was measured by the thin film XRD, and the measurement was 3.8 nm. The element composition on the surface of the film was measured by XPS with the detector angle of near 30°. It was revealed that the content of fluorine atoms on the surface was 51 atomic percent, the content of oxygen atoms was 16 atomic percent, and the O/F was 0.31.

<<Atmospheric Pressure Plasma Method>>

The following describes the details of the atmospheric pressure plasma method used for activation of the surface of the glass substrate and formation of the conductive SnO₂ film in the production of the aforementioned reading glass:

[Activation of Glass Substrate Surface by Atmospheric Pressure Plasma Method]

The glass substrate surface was activated under the following conditions of the process 1 alone, using an atmospheric pressure plasma apparatus of FIG. 1.

(Power Source Conditions)

Supperposed power source

High frequency power source 1: High frequency power source by Pearl Industry

Electric field frequency ω2: 13.56 MHz

Voltage V2: 6 kV

Current I2: 8 mA/cm²

Output density: 11 W/cm²

Discharge starting voltage IV1: 3.5 kV

High frequency power source 2: Impulse high frequency power source from Heiden Research Laboratory

Electric field frequency ω1: 100 kHz

Voltage V1: 6 kV

Current I1: 8 mA/cm²

Output density: 16 W/cm²

(Electrode Conditions)

The traveling frame electrode as the first electrode and the rectangular electrode as the second electrode were manufactured by ceramic spraying of the rectangular hollow titanium pipe as a dielectric.

Thickness of dielectric: 1 mm

Width of electrode: 40 mm

Applied electrode temperature: 90° C.

Gas between electrodes (G1 in FIG. 1): 4.5 mm

(Gas Conditions)

Discharge gas N₂: 20 slm

Auxiliary gas O₂: 1 slm

(Traveling Frame Electrode)

Traveling frame electrode temperature: 200° C.

The traveling frame electrode 8 of the process 1 was connected with the high frequency power source 1 (power source 31 of FIG. 1), and the rectangular electrode 3 was connected the high frequency power source 2 (power source 33 of FIG. 1). Back-and-forth traveling was carried out about ten times at a traveling speed of 100 mm/second.

[SnO₂ Film by Atmospheric Pressure Plasma]

The films of two steps (processes 1 and 2) were produced using the atmospheric pressure plasma apparatus of FIG. 1.

The power source on the high voltage side was measured by parallel connection of the rectangular electrode 3 of process 1 and the rectangular electrode 7 of process 2, the power source on the low voltage side was connected to the traveling frame electrode 8. In FIG. 1, the high frequency power source 31 alone is used as a power source. After a thin film has been formed under the reduction conditions of the following process 1, oxidation of process 2 was carried out. Processes 1 and 2 were repeated at a traveling speed of 200 mm/second, and back-and-forth traveling was carried out about 60 times, whereby a SnO₂ film having a thickness of 30 nm was formed.

(Conditions of Process 1)

<Power Source Conditions>

High frequency power source: High frequency power source from Pearl Industry of 27 MHz, 10 W/cm²

<Electrode Conditions>

Same as those for activation of the glass substrate surface

<Gas Conditions>

Argon gas for tetrabutyl tin gasification: 1 slm (standerd litter per minite), 100° C.

Discharge gas Ar: 10 slm

Auxiliary gas H₂: 0.02 slm

(Conditions of Process 2)

<Power Source Conditions>

High frequency power source: High frequency power source from Pearl Industry of 27 MHz, 20 W/cm²

<Electrode Conditions>

Thickness of dielectric: 1 mm

Width of electrode: 40 mm

Applied electrode temperature: 90° C.

Gas between electrodes: 4.5 mm

<Gas Conditions>

Discharge gas Ar: 10 slm

Auxiliary gas O₂: 0.5 slm

<Traveling Frame Electrode>

Traveling frame electrode temperature: 200° C.

<<Evaluation of Reading Glass>>

[Test by Actual Machine]

The reading glass produced in the aforementioned process was evaluated through a copying test conducted by the Model 7045 digital copier from Konica Minolta Business Technology.

A commercially available A3-sized sheet having a ream weight of 55 kg was used as a document, and 5,000 sheets were fed in the automatically continuous feed mode. After that, a JIS-specified Nichiban-made cellophane tape was cut to a length of 20 mm by a taper cutter, and the cut tapes were pasted in 14 columns by 7 rows on the commercially available A3-sized sheet having a ream weight of 55 kg. This sheet used as a evaluation document was fed four times through the aforementioned evaluation apparatus. The number of black streaks appearing on the fourth image printed out was evaluated as reflecting the trouble. After further sheets were fed, the upper plate was opened and the number of foreign substances accumulated on the reading glass was evaluated as the number of the dust deposits.

Further, a test of wiping off the ink of a felt tipped pen was conducted on the fed portion using a commercially available oil-based black felt tipped pen (Model 500-T1 from Zebra Co., Ltd.), and the test result was evaluated according to the following criteria:

<Evaluation Criteria for Test of Wiping Off the Ink of a Felt Tipped Pen>

B: Cannot write. Repellent to ink

C: Can write but can be removed by wiping

D: Cannot be removed by wiping

[Forced Abrasion Test]

Using the Model HEIDON-14DR abrasion tester, the surface of the reading glass the surface of the copying sheet having a ream weight of 55 g were subjected to an abrasion text at 1 kg/cm² 10,000 times at a speed of 20 mm/second. Then the element composition was measured by the XPS

Table 1 shows the result of evaluation obtained from the above test.

TABLE 1

| | Forced abrasion | | | | Test by actual machine | | |
|---|---|---|---|---|---|---|---|
| | test | | | | | | Wiping off |
| | (XPS element | | | | Number | Number | the ink of a |
| | composition) | | | | of dust | of black | felt tipped |
| Sample | F | O | C | O/F | deposits | streaks | pen |
| Comparative | 12 | 31 | 38 | 2.58 | 131 | 26 | D |
| example 1 | | | | | | | |
| Comparative | 14 | 30 | 35 | 2.14 | 89 | 23 | C |
| example 2 | | | | | | | |
| Example 1 | 32 | 25 | 28 | 0.78 | 6 | 4 | B |
| Example 2 | 51 | 14 | 28 | 0.27 | 2 | 1 | B |
| Example 3 | 50 | 13 | 26 | 0.26 | 0 | 0 | B |

As compared with the sample of the comparative example, the reading glass exhibited very small numbers of dust deposits and black streaks, and recorded a excellent results in the test of wiping off the ink of a felt tipped pen. This test result demonstrates that a fluorine containing film characterized by excellent durability has been formed. The test has also shown that the sample with a SnO₂ transparent conductive film formed on the rear surface shows still better results.

1. A glass member comprising:
a glass substrate including a fluorine containing film coated directly, not through any other layer interposed, on at least one surface of the glass substrate, wherein an element composition of the fluorine containing film is characterized in that a content of fluorine atoms exceeds 30 atomic percent, and an atomic ratio of oxygen atom to fluorine atom (O/F) is between 0.2 and 1.0.

2. A reading glass substrate located between a light source and a document in a scanner for optically reading the document, wherein a fluorine containing film is coated directly, not through any other layer interposed, on at least one surface of the glass substrate, and an element composition of the fluorine containing film is characterized in that a content of fluorine atoms exceeds 30 atomic percent, and an atomic ratio of oxygen atom to fluorine atom (O/F) is between 0.2 and 1.0.

3. The reading glass substrate of claim 2 wherein, before the fluorine containing film is formed, the surface of the glass substrate is provided with at least one of activations selected from among a corona treatment, a plasma treatment, an atmospheric pressure plasma treatment, and a flame treatment.

4. The reading glass substrate of claim 3 wherein the activation is the atmospheric pressure plasma treatment.

5. The reading glass substrate of claim 2 wherein the fluorine containing film partly includes an optical film to a thickness of 4 nm or less.

6. The reading glass of claim 2 wherein a surface opposite a surface of the glass substrate with the fluorine containing film coated thereon includes an antistatic layer.

7. The reading glass of claim 2 wherein both surfaces of the glass substrate include the fluorine containing film.

8. The reading glass of claim 2 wherein a process of forming the fluorine containing film is a wet coating process.

9. A reading apparatus utilizing the reading glass substrate of claim 2.

10. An image forming apparatus provided with the reading apparatus of claim 9.
